(19) United States
(12) Patent Application Publication
(10) Pub. No.: US 2010/0283759 A1
(43) Pub. Date: Nov. 11, 2010

(54) TOUCH SENSOR SYSTEM AND MICROCOMPUTER

(75) Inventors: Yoshimi ISO, Tokyo (JP); Minoru Kishi, Tokyo (JP); Yukihisa Naoe, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/774,724

(22) Filed: May 5, 2010

(30) Foreign Application Priority Data
May 7, 2009 (JP) 2009-112654

(51) Int. Cl. G06F 3/045

(52) U.S. Cl. 345/174

(57) ABSTRACT

Detecting a touch on a touch sensor is performed using a microcomputer without requiring a large-resistance resistor. A capacitive electrode of the touch sensor is coupled to an external terminal of the microcomputer. The microcomputer comprises a current source circuit (e.g., constant current circuit) and an interface section which are coupled to the external terminal, a counter circuit coupled to the interface section, and a central processing unit (CPU). The CPU, after initializing accumulated charge on the touch sensor by an output circuit of the interface section, integrates charge onto the touch sensor with an output current of the current source circuit, acquires a time interval counted by the counter circuit until a signal obtained from an input circuit of the interface section inverts, and discerns whether or not the touch sensor has been touched, depending on the time count value.

### CROSS-REFERENCE TO RELATED APPLICATIONS

The disclosure of Japanese Patent Application No. 2009-112654 filed on May 7, 2009 including the specification, drawings and abstract is incorporated herein by reference in its entirety.

### BACKGROUND OF THE INVENTION

The present invention relates to a touch sensor system for detecting a touch on a touch sensor and a microcomputer suitable for that system.

As techniques for detecting a touch on a capacitance type touch sensor, for example, as represented by those described in Patent Documents 1 and 2, it is widely known that a resistor is coupled to a capacitive electrode of a touch sensor and detecting whether or not the touch sensor has been touched is done based on change in a charging or discharging curve in accordance with the CR time constant. For example, a human body has an electrostatic capacitance of about 8 pF. This value of capacitance, when added, causes a change in the charging or discharging curve in accordance with the CR time constant. This changed state can be detected by a difference in time until the curve goes across a threshold voltage.

### PRIOR ART DOCUMENTS

### Patent Documents

### [Patent Document 1]

### Japanese Unexamined Patent Publication No. 2004-357744

### [Patent Document 2]

### Japanese Unexamined Patent Publication No. 2008-102885

### SUMMARY OF THE INVENTION

The present inventors examined the techniques for detecting a touch on a touch sensor, using the above-mentioned CR time constant. According to this examination, a change in capacitance due to a human finger touch is so small that a resistor having a large resistance of several megohms must be coupled to the touch sensor and such a large-resistance resistor must be procured and installed individually on a substrate. For example, in a case where a microcomputer is used for detection processing, not only a capacitive electrode of a touch sensor but also a large-resistance resistor for each capacitive electrode must be externally attached to input/output ports of the microcomputer, thus resulting in an increase in man-hours and an increase in the number of externally attached parts.

An object of the present invention is to provide a touch sensor system capable of detecting a touch on a touch sensor using a microcomputer without requiring a large-resistance resistor as well as a microcomputer suitable for the touch sensor system.

The above-noted and other objects and novel features of the present invention will become apparent from the following description in the present specification and the accompanying drawings.

A typical aspect of the invention disclosed in this application is summarized as follows.

A capacitive electrode of the touch sensor is coupled to an external terminal of the microcomputer. The microcomputer comprises a current source circuit (e.g., a constant current circuit) and an interface section which are coupled to the external terminal, a counter circuit coupled to the interface section, and a central processing unit (CPU). The CPU, after initializing accumulated charge on the touch sensor by an output circuit of the interface section, integrates charge onto the touch sensor with an output current of the current source circuit and acquires a time interval until a signal obtained from an input circuit of the interface section inverts by counting with the counter circuit, and discerns whether or not the touch sensor has been touched based on the time count value.

Since the current required for integrating the charge onto the initialized touch sensor is supplied by the constant current circuit in the microcomputer, it is not needed to attach an external large-resistance resistor to the microcomputer.

Effect obtained by the typical aspect of the invention disclosed in the present application is outlined below.

It is possible to detect a touch on a touch sensor using a microcomputer without using a large-resistance resistor.

### BRIEF DESCRIPTION OF THE DRAWINGS

FIG. 1 is a block diagram illustrating a touch sensor system using a discharging-type constant current circuit.

FIG. 2 is a circuit diagram illustrating a discharging-type constant current circuit in which a current mirror ratio is selectable.

FIG. 3 is a circuit diagram showing an example in which a bandgap reference circuit is applied for the constant current circuit 18.

FIG. 4 is a block diagram illustrating a universal input/output port for one bit (port unit) as one example of an interface section 20.

FIG. 5 is a block diagram illustrating a touch sensor system in which an output buffer and an input buffer are coupled to separate external terminals used for detecting a touch on the touch sensor in contrast with FIG. 1.

FIG. 6 is a block diagram illustrating a touch sensor system using a charging-type constant current circuit.

FIG. 7 is a circuit diagram illustrating a charging-type constant current circuit.

FIG. 8 is a block diagram illustrating a touch sensor system in which an output buffer and an input buffer are coupled to separate external terminals used for detecting a touch on the touch sensor in contrast with FIG. 6.

FIG. 9 is a timing chart illustrating an operation of detecting a touch on the touch sensor in the touch sensor system of FIG. 1.

FIG. 10 is a timing chart illustrating an operation of detecting a touch on the touch sensor in the touch sensor system of FIG. 6.

### DETAILED DESCRIPTION OF THE PREFERRED EMBODIMENTS

### 1. General Outline of Embodiments

To begin with, exemplary embodiments of the present invention disclosed herein are outlined. In the following general description of exemplary embodiments, reference designators in the drawings, which are given for referential purposes in parentheses, are only illustrative of elements that fall in the concepts of the components identified by the designators.

[1] A touch sensor system pertaining to an exemplary embodiment of the present invention comprises a microcomputer (1, 1A, 1B) and a touch sensor (2) whose capacitive electrode is coupled to an external terminal (P1, P1A, P1B) of the microcomputer. The microcomputer comprises a current source circuit (18, 18A) coupled to the external terminal, an interface section (20) coupled to the external terminal, a counter circuit (19) coupled to the interface section, and a central processing unit (CPU) (10) controlling the interface section and the counter circuit. The CPU, after initializing accumulated charge on the touch sensor by an output circuit (75) of the interface section, integrates charge onto the touch sensor with an output current of the current source circuit and acquires a time interval until a signal obtained from an input circuit (87) of the interface section inverts by counting with the counter circuit, and discerns whether or not the touch sensor has been touched.

The current required for integrating charge onto the initialized touch sensor is supplied by the current source circuit in the microcomputer. Therefore, it is not needed to attach an external large-resistance resistor to the microcomputer.

[2]< Use of a discharging-type constant current circuit> In the touch sensor system as set forth in [1], for example, the output circuit initializes accumulated charge on the touch sensor by charging operation. The current source circuit is a discharging-type constant current circuit (18) to draw current from an external terminal. The CPU, after charging the touch sensor with the output circuit, causes the constant current circuit to discharge the touch sensor by drawing the current from an external terminal, acquires a time interval by counting with the counter circuit until a signal obtained from the input circuit inverts due to this discharging current, and discerns whether or not the touch sensor has been touched depending on whether or not the time count value has exceeded a threshold value. By thus discharging the initially accumulated charge on the touch sensor, it is possible to detect a touch on the touch sensor.

[3]<Common terminal> In the touch sensor system as set forth in [2], for example, the external terminal (P1) is a common terminal shared by the output circuit and the input circuit. The CPU, after charging the touch sensor with the output circuit, places the output circuit in a high output impedance state. It is possible to minimize the number of external terminals for use to detect a touch on the touch sensor.

[4]<Separate terminals> In the touch sensor system as set forth in [2], the output circuit and the input circuit are coupled to separated external terminals (P1A, P1B) respectively. A diode allowing current to flow in a forward direction from a first external terminal (P1A) for the output circuit to a second external terminal (P1B) for the input circuit is located between the first and second separated external terminals. The input circuit and the output circuit of the interface section are coupled to separated terminals and a diode (5) separates between the output circuit and input circuit electrically. Accordingly, parasitic capacitance of the output circuit caused by a source-drain capacitance of larger transistors than the input circuit has no influence on current integration operation during input operation by the input circuit. So it is possible to detect a touch with high precision. A switch may be used instead of the diode; in that case, an additional external terminal for controlling the switch is needed.

[5]< Use of a charging-type constant current circuit> In the touch sensor system as set forth in [1], for example, the output circuit initializes accumulated charge on the touch sensor by discharging operation. The current source circuit is a charging-type constant current circuit (18A) to supply current to an external terminal. The CPU, after discharging the touch sensor by the output circuit, causes the constant current circuit to supply current, acquires a time interval counted by the counter circuit until a signal obtained from the input circuit inverts due to this current supply, and discerns whether or not the touch sensor has been touched depending on whether or not the time count value has exceeded a threshold value. By thus charging the initialized touch sensor, it is possible to detect a touch on the touch sensor.

[6]<Common terminal> In the touch sensor system as set forth in [5], the external terminal is a common terminal shared by the output circuit and the input circuit. The CPU, after discharging the touch sensor by the output circuit, places the output circuit in a high output impedance state. It is possible to minimize the number of external terminals for use to detect a touch on the touch sensor.

[7]<Separate terminals> In the touch sensor system as set forth in [5], for example, the output circuit and the input circuit are coupled to separate external terminals respectively. A diode (6) allowing current to flow in a forward direction from a second external terminal for the input circuit to a first external terminal for the output circuit is located between the first and second separate external terminals. The input circuit and the output circuit of the interface section are coupled to separate terminals and a diode intervenes between the terminals for electrical separation. Accordingly, a source-drain parasitic capacitance of the output circuit employing larger transistors than in the input circuit has no influence on current integration operation during input operation by the input circuit. It is possible to detect a touch with high precision. A switch may be used instead of the diode; in that case, an additional external terminal for controlling the switch is needed.

[8]<Mirror current depending on an externally attached resistor> In the touch sensor system as set forth in [1], for example, the current source circuit is a constant current circuit, this constant current circuit comprises a current mirror circuit, and the current mirror circuit outputs a current whose value is set depending on a resistance value of a resistor (4) that is externally attached to the microcomputer via dedicated terminals. One externally attached resistor is only necessary and its resistance value is smaller than a resistor which would be installed in series with the touch sensor in conventional cases.

[9]<Current mirror ratio selecting circuit> In the touch sensor system as set forth in [1], for example, the current source circuit is a constant current circuit, this constant current circuit comprises a current mirror circuit in which a current mirror ratio of output current is selected by a selection circuit (41-46), and the current mirror circuit outputs a current whose value is set depending on the current mirror ratio selected. Integration operation required can be selected by selecting a current mirror ratio.

[10]<Selecting an output current value that is inversely proportional to a counter clock frequency> In the touch sensor system as set forth in [9], the CPU causes the selection circuit to select a current mirror ratio in accordance with a relation that a current value determined by the current mirror ratio is inversely proportional to the frequency of a clock signal used for counting operation of the counter circuit. Depending on the frequency of the clock signal, a current mirror ratio is selected to output a current value that is inversely proportional to the frequency of the clock signal. Owing to this relation, even if the frequency of the clock signal used for the counting operation of the counter changes, the time taken for integration operation for charging or discharging the touch sensor does not change. Thus, there is no need to change the processing operation by the CPU and the processing program to predefine this. Even if the operation clock frequency of the microcomputer changes, the operation program that is executed by the CPU to detect a touch on the touch sensor may be the same.

[11] The touch sensor system as set forth in [10], for example, further comprises a clock pulse generator (14) generating an operation reference clock signal with a variable frequency for the CPU, wherein the clock signal used for counting operation of the counter circuit has a predefined frequency division ratio to the operation reference clock signal. Even if the frequency of the operation reference clock signal generated by the clock pulse generator dynamically varies depending on mode such as a low power consumption mode, the operation program that is executed by CPU to detect a touch on the touch sensor may be the same.

[12] In the touch sensor system as set forth in [11], for example, the CPU controls the frequency of the operation reference clock signal.

[13] In the touch sensor system as set forth in [12], for example, the CPU reads, in response to a power-on reset, selection control data that determines a current mirror ratio from a nonvolatile memory (12) and initially sets the selection control data in the selection circuit.

[14] A touch sensor system pertaining to another exemplary embodiment of the present invention comprises a microcomputer and a touch sensor whose capacitive electrode is coupled to an external terminal of the microcomputer. The microcomputer comprises a constant current circuit coupled to the external terminal, an interface section coupled to the external terminal, a counter circuit coupled to the interface section, a central processing unit (CPU), and a clock pulse generator generating an operation reference clock signal with a variable frequency for the CPU. A clock signal used for counting operation of the counter circuit has a predefined frequency division ratio to the operation reference clock signal. The constant current circuit comprises a current mirror circuit in which a current mirror ratio of output current is selected by a selection circuit and the selection circuit selects a current mirror ratio in accordance with a relation that a current value determined by the current mirror ratio is inversely proportional to the frequency of the clock signal used for counting operation of the counter circuit. The CPU, after initializing accumulated charge on the touch sensor by an output circuit of the interface section, integrates charge onto the touch sensor with an output current of the constant current circuit, acquires a time interval counted by the counter circuit until a signal obtained from an input circuit of the interface section inverts, and discerns whether or not the touch sensor has been touched.

[15] A microcomputer pertaining to another exemplary embodiment of the present invention is a microcomputer with an external terminal to which a capacitive electrode of a touch sensor is coupled, the microcomputer comprising a current source circuit coupled to the external terminal, an interface section coupled to the external terminal, a counter circuit coupled to the interface section, and a central processing unit (CPU) controlling the interface section and the counter circuit. The CPU, after initializing accumulated charge on the touch sensor by an output circuit of the interface section, integrates charge onto the touch sensor with an output current of the current source circuit, acquires a time interval counted by the counter circuit until a signal obtained from an input circuit of the interface section inverts, and discerns whether or not the touch sensor has been touched.

[16] In the microcomputer as set forth in [15], for example, the output circuit initializes accumulated charge on the touch sensor by charging operation. The current source circuit is a discharging-type constant current circuit to draw current from an external terminal. The CPU, after charging the touch sensor by the output circuit, causes the constant current circuit to draw current, acquires a time interval counted by the counter circuit until a signal obtained from the input circuit inverts due to this current draw, and discerns whether or not the touch sensor has been touched depending on whether or not the time count value has exceeded a threshold value.

[17] In the microcomputer as set forth in [15], for example, the output circuit initializes accumulated charge on the touch sensor by discharging operation. The current source circuit is a charging-type constant current circuit to supply current to an external terminal. The CPU, after discharging the touch sensor by the output circuit, causes the constant current circuit to supply current, acquires a time interval counted by the counter circuit until a signal obtained from the input circuit inverts due to this current supply, and discerns whether or not the touch sensor has been touched depending on whether or not the time count value has exceeded a threshold value.

[18] A microcomputer pertaining to another exemplary embodiment of the present invention comprises a constant current circuit coupled to the external terminal, an interface section coupled to the external terminal, a counter circuit coupled to the interface section, a central processing unit (CPU), and a clock pulse generator generating an operation reference clock signal with a variable frequency for the CPU. A clock signal used for counting operation of the counter circuit has a predefined frequency division ratio to the operation reference clock signal. The constant current circuit comprises a current mirror circuit in which a current mirror ratio of output current is selected by a selection circuit and the selection circuit selects a current mirror ratio in accordance with a relation that a current value determined by the current mirror ratio is inversely proportional to the frequency of the clock signal used for counting operation of the counter circuit. The CPU, after initializing accumulated charge on the touch sensor by an output circuit of the interface section, integrates charge onto the touch sensor with an output current of the constant current circuit, acquires a time interval until a signal obtained from an input circuit of the interface section inverts by counting with the counter circuit, and discerns whether or not the touch sensor has been touched.

### 2. Details on Embodiments

Embodiments of the invention will now be described in greater detail.

[symbol] Touch Sensor System Using a Discharging-Type Constant Current Circuit

[symbol]

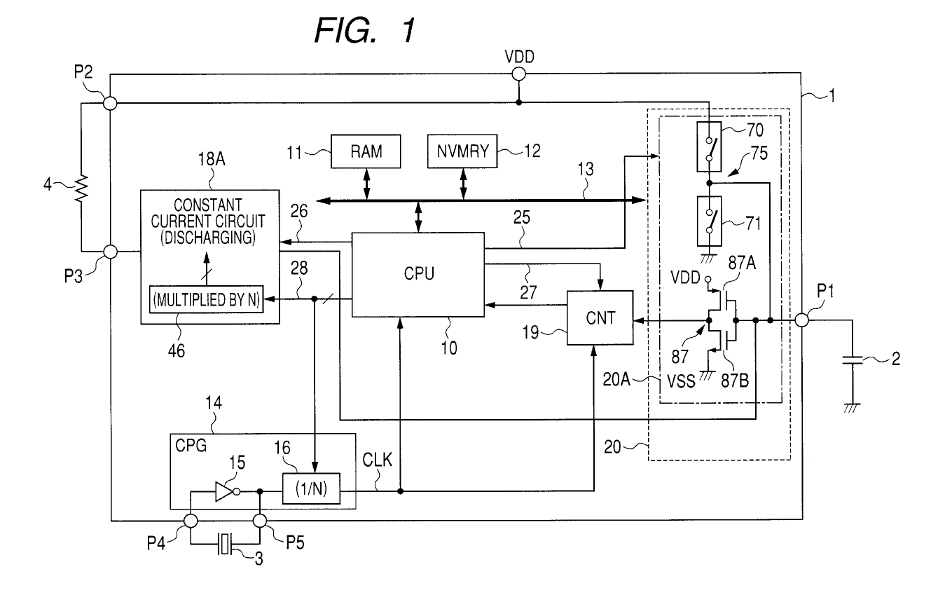

FIG. 1 illustrates a configuration of a touch sensor system pertaining to the present invention. The touch sensor system comprises a microcomputer 1 and a touch sensor 2. One capacitive electrode of the touch sensor 2 is coupled to an external terminal P1 of the microcomputer 1. Although not restrictive, the microcomputer 1 is formed on a single semiconductor substrate such as a monocrystalline silicon substrate by a complementary MOS integrated circuit fabrication technology or the like. The microcomputer 1 includes a central processing unit (CPU) 10 which executes a program, a RAM 11 which is used as a working area for the CPU 10 or a temporary storage area of data, an electrically rewritable nonvolatile memory (NVMRY) 12 like a flash memory in which programs to be executed by the CPU 10 and initialization data are stored, a clock pulse generator (CPG) 14, an interface section 20 which is shown representatively, a discharging-type constant current circuit 18, and a counter (CNT) 19 as the counter circuit. Referential numeral 13 denotes an internal bus. The configuration required for detecting a touch on the touch sensor 2 is shown here. Needless to say, the microcomputer 1 may be provided with another interface section and peripheral circuit modules required for other data processing.

The interface section 20 is provided with an output buffer 75 as a push-pull output circuit formed by, e.g., a p-channel output MOS transistor 70 and an n-channel output MOS transistor 71 which are coupled serially and an input buffer 87 as a push-pull input circuit formed by a p-channel input MOS transistor 87A and an n-channel input MOS transistor 87B which are coupled serially. An output node of the output buffer 75 and an input node of the input buffer 87 are both coupled to the above external terminal P1 in common. Output operation and input operation of the interface section 20 are controlled by signals 25 which are supplied from the CPU 10.

The constant current circuit 18 generates a constant current resulting from the fact that a current supplied from a power-supply voltage VDD passes through a resistor 4 which is externally attached between external terminals P2 and P3. The constant current circuit 18 includes a current mirror circuit that determines a value of constant current and a current mirror ratio which is selected by the current mirror circuit is determined by control data 28 that the CPU 10 gives to a selection control circuit 46. A constant current draw-in node is coupled to the above external terminal P1. A constant current draw operation starts in synchronization with an input operation of the input buffer 87 and a command therefor is given by a signal 26 from the CPU 10.

The clock pulse generator 14 generates a clock signal CLK that is used as an operation reference clock signal for the CPU 10. Oscillation is carried out by a ring oscillator comprised of an oscillator 3 which is externally attached between clock terminals P4 and P5 and an inverter 15 having an odd number of inversion stages and a resulting oscillation signal frequency is diminished to a fraction of N by a frequency divider circuit 16. A ratio of frequency division by the frequency divider circuit 16 is determined by control data 28 that the CPU 10 outputs. The CPU 10 performs data processing in synchronization of this clock signal CLK.

The counter 19 counts cycles of the clock signal CLK: the clock signal having a predefined frequency division ratio to the operation reference clock signal for the CPU 10. The counter 19 starts a counting operation in synchronization with an input operation of the input buffer 87 and terminates the counting operation in synchronization with when it is judged that a high level signal appears at an output node of the input buffer 87. A command to start the counting operation is given by a signal 27 from the CPU 10.

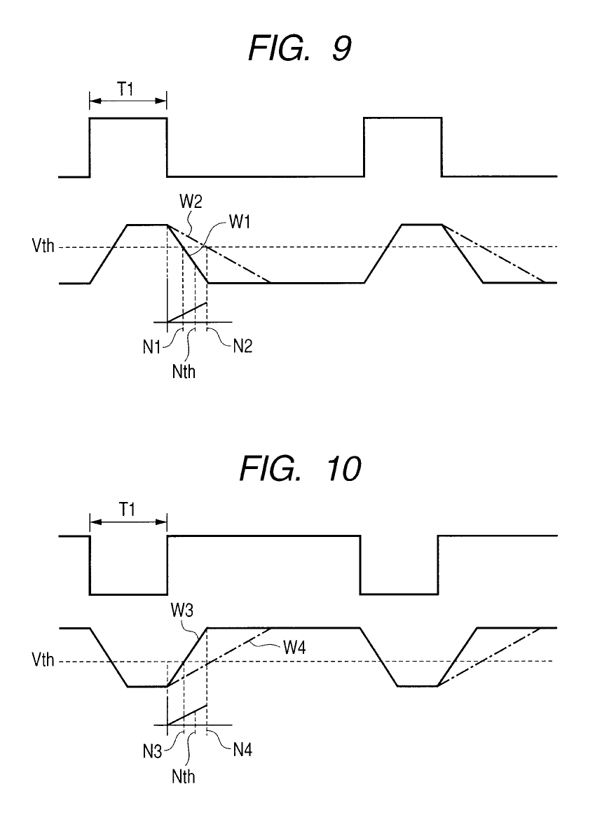

The CPU 10 causes the output MOS transistor 70 of the output buffer 75 to output a high level signal to charge and initialize the touch sensor 2. After that, the CPU 10 causes the output buffer 75 in a high impedance state and causes the constant current circuit 18 to start the constant current draw operation. Concurrently, the CPU 10 causes the input buffer 87 to start the input operation and causes the counter 19 to start the counting operation. Due to the current draw operation of the constant current circuit 18, the touch sensor 2 is charged gradually. Once the charge level of the input buffer 87 has exceeded a logical threshold voltage, the output signal of the input buffer 87 inverts from a low level to a high level, synchronously with which the counting operation of the counter 10 stops. CPU 10 acquires the count value of the counter 10, for example, via a count-up interrupt, and discerns whether or not a person has touched the touch sensor 2. If a person has touched the touch sensor 2, the touch makes an increase of about 5 pF equivalent to human capacitance in a capacitance component observed at the external terminal P1. In a case where the count value of the counter 19 exceeds a threshold value, the CPU 10 determines that a person has touched the touch sensor. For example, in a timing chart of FIG. 9, if T1 is assumed to be a charging period by the output buffer 75, the potential of the external terminal P1 changes along a waveform W1 when a person has not touched the touch sensor 2, whereas it changes along a waveform W2 when a person has touched the touch sensor 2. If Vth is assumed to be a logical threshold voltage of the input buffer 87, the input buffer voltage changes along the waveform W1 when a person has not touched the touch sensor 2 or changes along the waveform W2 when a person has touched the touch sensor 2. The count value of the counter 19 when a person has not touched the touch sensor 2 is regarded to equal a value of N1 counted at a time when the waveform W1 goes across the threshold voltage Vth. The count value of the counter 19 when a person has touched the touch sensor 2 is regarded to equal a value of N2 counted at a time when the waveform W2 goes across the threshold voltage Vth. If the count value is smaller than its threshold value Nth, the CPU 10 determines that a person has not touched the touch sensor 2. If the count value is greater than its threshold value Nth, the CPU 10 determines that a person has touched the touch sensor 2.

As noted from the above, the current required for integrating charge onto the initialized touch sensor is supplied by the constant current circuit 18 internal to the microcomputer. Therefore, it is not needed to externally attach a large-resistance resistor in series with the touch sensor 2 to the microcomputer. Furthermore, since current that is drawn to the external terminal P1 is a constant current and a level of discharging the touch sensor 2 is proportional to time, a high precision of detecting a touch is achieved.

[symbol] Constant Current Circuit in which a Current Mirror Ratio is Selectable

[symbol]

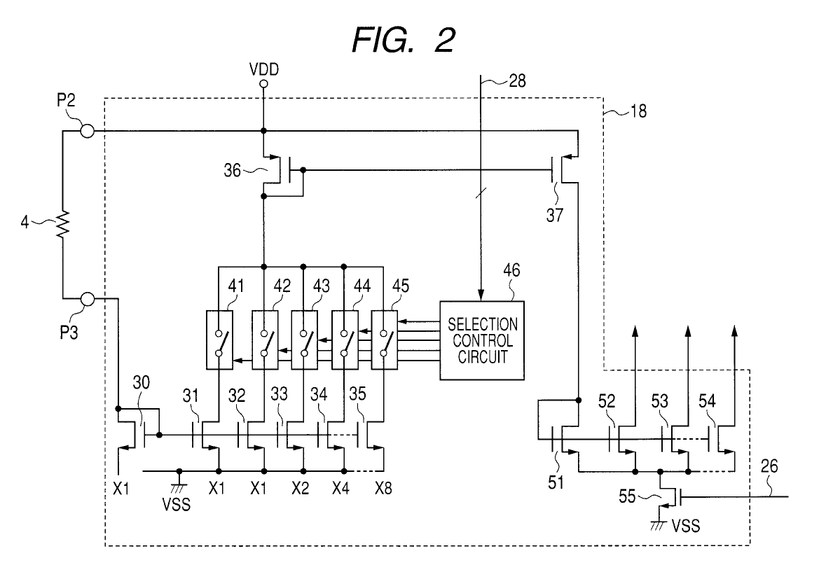

FIG. 2 illustrates a discharging-type constant current circuit in which a current mirror ratio is selectable. The constant current circuit 18 includes, as a first stage of a current mirror circuit, a drain-gate coupled n-channel MOS transistor 30 to which the power supply voltage VDD is supplied via the resistor 4, n-channel MOS transistors 31-35 to mirror the drain-source current of the MOS transistor 30, select switches 41-45 coupled to the drains of the MOS transistors 31-35, and a selection control circuit 46 which controls switching of the select switches 41-45. Assuming that the W/L (gate width/gate length) of the MOS transistor 30 is X1, the W/L of each of the following MOS transistors 31-35 may be set to, for example, X1, X1, X2, X3, X4 in order. Depending on a combination of the ON states of the select switches 41-45, a current mirror ratio can be selected. Selecting which of the switches 41-45 to be ON by the selection control circuit 46 is determined by control data 28 supplied from the CPU 10.

In the next stage, there is provided a mirror circuit comprised of a drain-gate coupled p-channel MOS transistor 36 located between a common coupling node for the select switches 41-45 and the power supply voltage VDD and a p-channel MOS transistor 37 to mirror the source-drain current of the MOS transistor 36. In the final stage, there is provided a mirror circuit comprised of a drain-gate coupled n-channel MOS transistor 51 which receives current flowing through the MOS transistor 37 and n-channel MOS transistors 52-54 to mirror the drain-source current of the MOS transistor 51. For example, the drain of the MOS transistor 52 is coupled to the external terminal P1. Although a single touch sensor 2 is shown by way of example in FIG. 1, a plurality of interface sections 20 and external terminals P2 may practically be provided and the counter 19 may be adapted to receive a plurality of channels to enable detecting whether or not a number of touch sensors are touched. Correspondingly, the constant current circuit 18 is also provided with a plurality of MOS transistors for current draw. Referential numeral 55 denotes a power switch MOS transistor of the final-stage current mirror circuit. When the MOS transistor 55 is placed in an ON state by a signal 26, the current draw operation to the external terminal P1 is performed.

A current that is supplied from the power supply voltage VDD to the constant current circuit 18 is regulated by the resistor 4. However, one externally attached resistor 4 is only necessary and its resistance value is smaller than a resistor which would be installed in series with the touch sensor in conventional cases.

[symbol] Selecting an Output Current Value that is Inversely Proportional to the Clock Frequency of the Counter

[symbol]

Because of the use of the constant current circuit 18 in which a current mirror ratio that determines a draw-in current is selectable, an integration operation required can be selected by selecting a current mirror ratio. In particular, the CPU 10 controls the current mirror ratio of the constant current circuit 18 and the frequency division ratio of the clock pulse generator 14 using control data 28, so that the product of the frequency of the clock signal CLK used for the counting operation of the counter and the draw-in current output by the constant current circuit 18 will be constant. In other words, the CPU 10 causes the select switches 41-45 to select the current mirror ratio in accordance with a relation that the current value determined by the current mirror ratio is inversely proportional to the frequency of the clock signal used for the counting operation of the counter 19. That is, given that the frequency of the clock signal CLK is m MHz and the current ratio is n, if the frequency of the clock signal CLK is m/2 MHz, then the current mirror ratio is set to 2n. Accordingly, even if the frequency of the clock signal CLK used for the counting operation of the counter 19 changes, the time taken for the integration operation for discharging the touch sensor 2 does not change. Thus, there is no need to change the processing operation by the CPU 10 and the processing program to predefine this. Even if the operation clock frequency CLK of the microcomputer 1 changes depending on the applied system, the operation program that is executed by CPU 10 to detect a touch on the touch sensor 2 can be the same. Moreover, even if the frequency of the operation reference clock signal CLK that is generated by the clock pulse generator 14 dynamically varies depending on the operation mode of the microcomputer 1, such as a low power consumption mode and a high speed operation mode, the operation program that is executed by CPU 10 to detect a touch on the touch sensor 2 can be the same.

To initially set the current mirror ratio of the constant current circuit 18 and the frequency division ratio of the frequency divider circuit 16, the CPU 10 can read, in response to, for example, a power-on reset, control data 28 that determines the current mirror ratio and the frequency division ratio from the nonvolatile memory 12, set this data in the selection control circuit 46, and rewrite the default value of the frequency divider circuit 16 with the control data 28.

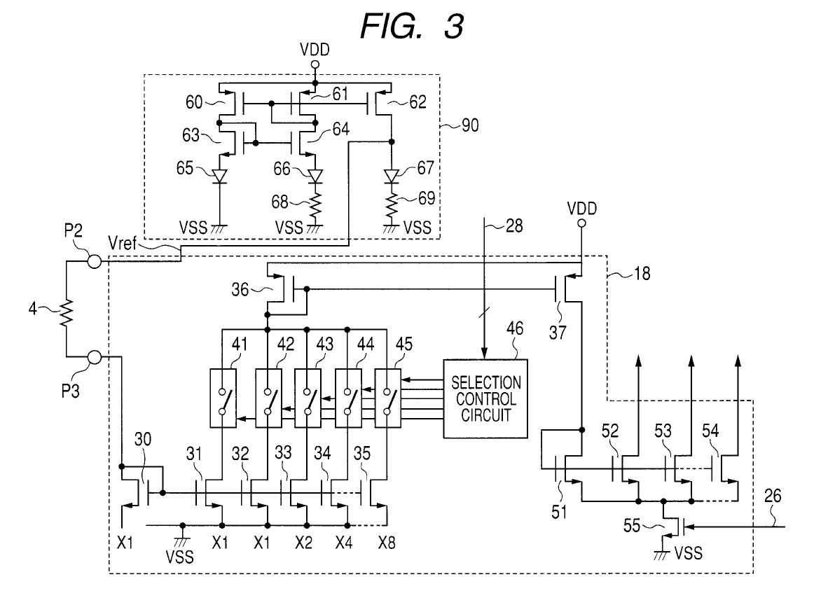

FIG. 3 shows an example in which a bandgap reference circuit is applied for use with the constant current circuit 18. The bandgap reference circuit 90 includes a current generating circuit and a current-voltage conversion circuit. The current generating circuit includes p-channel MOS transistors 60, 61 forming a first current mirror circuit, n-channel MOS transistors 63, 64 forming a second current mirror circuit, diodes 65, 66, and a resistor 68 (with a resistance value of R1). Given that Boltzmann constant is k, absolute temperature is T, the elementary charge amount of electrons is q, the junction areas of the diodes 65 and 66 are S3 and S4 respectively, where a ratio between the junction areas S4/S3 is N, the drain-source current IP61 of the MOS transistors 60, 61 is expressed as IP61=(1/R1)·(kT/q)·1n(N) . . . (1). The current-voltage conversion circuit includes a p-channel MOS transistor 62, a resistor 69 (with a resistance value of R2), a diode 67, and converts the constant current IP61 supplied from the current generating circuit 14 into a voltage. Thereby, a reference voltage Vref can be produced from the drain of the MOS transistor 62. Given that a forward voltage of the diode D5 is VG, the reference voltage Vref is expresses as Vref=(R11/R10)·(kT/q)·1n(N)+VF . . . (2). Accordingly, by appropriately selecting the resistance values of the resistors 68 and 69 and the value N of the ratio between the junctions areas of the diodes 65 and 66, a reference voltage Vref can be produced as an output voltage that is relatively unaffected by temperature.

By using such a reference voltage Vref as the power supply for operation of the constant current circuit 18, the constant current circuit 18 can generate a draw-in current that is little-affected by temperature and it becomes possible to detect a touch on the touch sensor 2 with even higher precision.

[symbol] Interface Section

[symbol]

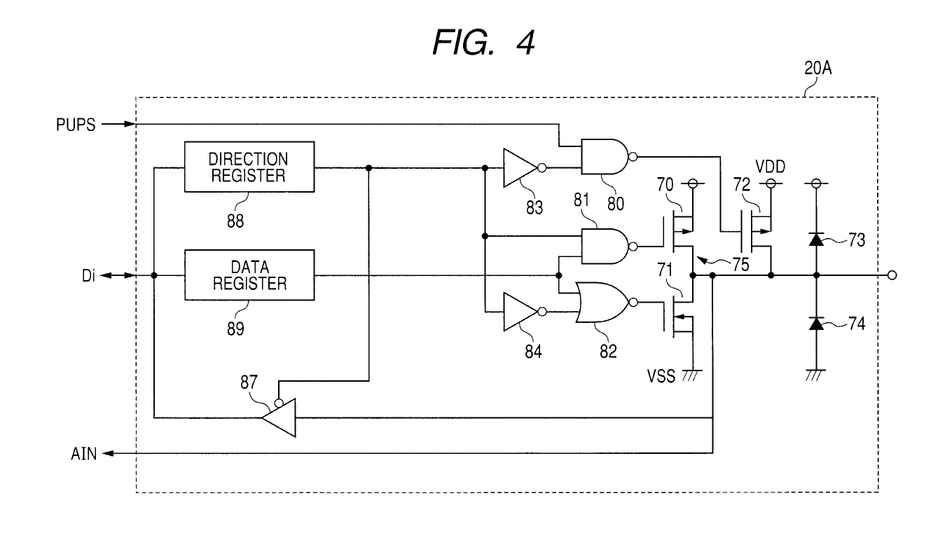

FIG. 4 illustrates a universal input/output port for one bit (port unit) as one example of the interface section 20. The port unit 20A of the universal input/output port includes, besides the MOS transistors 70, 71 forming the input buffer 87 and the output buffer 75, a p-channel pull-up MOS transistor 72 and diodes 73, 74 for preventing electrostatic breakdown. The port unit 20A is further provided with NAND gates 80, 81, NOR gate 82, and inverters 83, 84 which form logics for controlling the operations of the input buffer 87, the output buffer 75, and the pull-up MOS transistor and also includes a direction register 88 and a data register 89. PUPS denotes a pull-up select signal, AIN denotes analog input, and Di denotes one bit of a data signal carried on the internal bus. In practice, the microcomputer 1 is equipped with a plurality of port units. Here, one port unit 20A is used for detecting a touch on the touch sensor. When a low level is output by the direction register 88, the output buffer 75 is placed in a high output impedance state and the input buffer 87 is made capable of input operation. When a high level is output by the direction register 88, the input operation of the input buffer 87 is inhibited and the output buffer 75 is made capable of outputting a signal of a logical value in accordance with the value of the data register 8.

In the case where one port unit is used as a minimum unit for detecting a touch on the touch sensor as illustrated in FIG. 4 and the external terminal P1 is shared by the output buffer 75 and the input buffer 87, the CPU 10 needs to place the output buffer 75 in the high output impedance state, after charging the touch sensor 2 by the output buffer 75. By thus sharing the external terminal P1 by the output buffer 75 and the input buffer 87, the number of external terminals used to detect a touch on the touch sensor 2 can be reduced in comparison with a case where these buffers are coupled to separate external terminals.

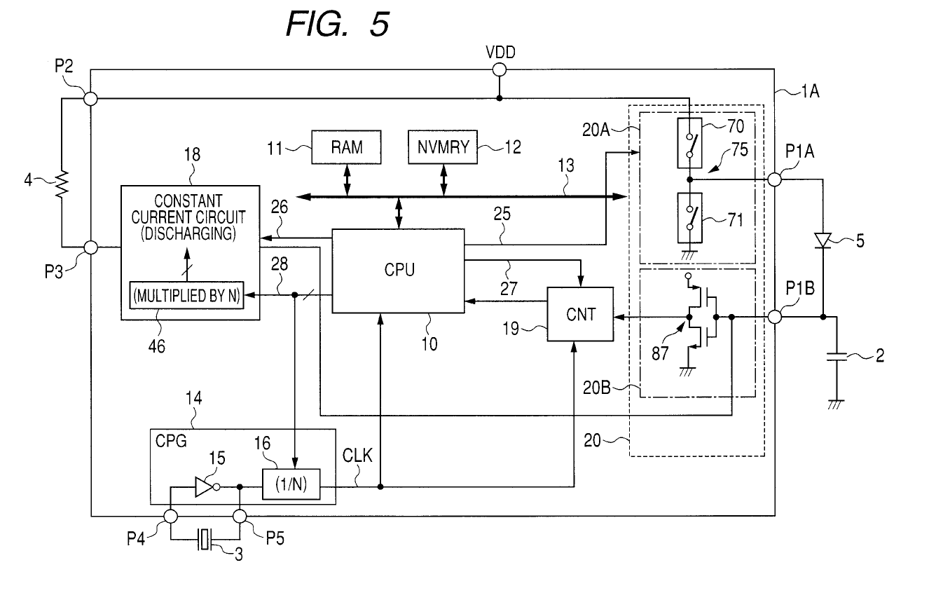

FIG. 5 shows an example in which the output buffer 75 and the input buffer 87 are coupled to separated external terminals used for detecting a touch on the touch sensor. In the microcomputer 1A of FIG. 5, P1A is an external terminal assigned to the output buffer 75 and P1B is an external terminal assigned to the input buffer 87. A diode 5 that allows current to flow in a forward direction from the external terminal P1A to the terminal P1B is located between the external terminals P1A and P1B. A capacitive electrode of the touch sensor 2 is coupled to the external terminal P1B. In the interface section 20, one port unit 20A uses only the output buffer 75 for output operation to initialize the touch sensor 2. A current draw-in node for the constant current circuit 18 is coupled to the external terminal P1B. The input buffer 87 coupling to the external terminal P1B is included in a unit circuit 20B different from the port unit 20A. The unit circuit 20B has no output buffer and, at the input node of the input buffer 87, there does not exist a large input capacitance like a source-drain parasitic capacitance of the output buffer employing larger MOS transistors than in the input buffer. The output buffer 75 and the input buffer 87 are coupled to the separated external terminals P1A, P1B and the diode 5 allowing current to flow in the forward direction from the external terminal P1A for output to the external terminal P1B for input is located between the separated external terminals P1A, P1B. Because a large input parasitic capacitance of the output buffer 75 is not observed from the external terminal P1B, the input parasitic capacitance of the output buffer 75 has no influence on the current integration operation during input operation by the input buffer 87. Accordingly, it is possible to detect a touch with even higher precision. In the case of FIG. 5, during the input operation by the input buffer 87, the output buffer 75 must be placed in the high output impedance or low level output state. A switch may be used instead of the diode. In that case, however, an additional external terminal for controlling the switch is needed and a source-drain parasitic capacitance of the switch is likely to produce an undesired input capacitance.

[symbol] Touch Sensor System Using a Charging-Type Constant Current Circuit

[symbol]

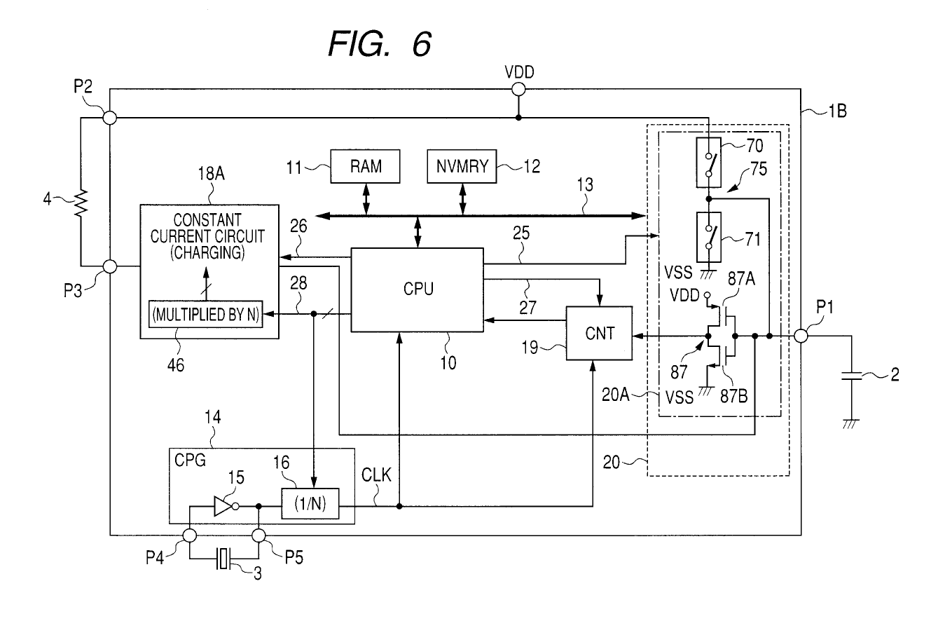

FIG. 6 illustrates a touch sensor system using a charging-type constant current circuit. In the case of using the charging-type constant current circuit, the output buffer 75 initializes accumulated charge on the touch sensor 2 by discharging operation. The constant current circuit 18A is a charging-type that supplies current to the external terminal P1. After the touch sensor 2 is discharged by the output buffer 75, the CPU 10 causes the constant current circuit 18A to supply current, acquires a time interval counted by the counter 19 until a signal obtained from the input buffer 87 inverts due to this current supply, and discerns whether or not the touch sensor 2 has been touched depending on whether or not the time count value has exceeded a threshold value Nth. For example, in a timing chart of FIG. 10, if T1 is assumed to be a discharging period by the output buffer 75, the potential of the external terminal P1 changes along a waveform W3 when a person has not touched the touch sensor 2, whereas it changes along a waveform W4 when a person has touched the touch sensor 2. If Vth is assumed to be a logical threshold voltage of the input buffer 87, the input buffer voltage changes along the waveform W3 when a person has not touched the touch sensor 2 or changes along the waveform W4 when a person has touched the touch sensor 2. The count value of the counter 19 when a person has not touched the touch sensor 2 is regarded to equal a value of N3 counted at a time when the waveform W3 goes across the threshold voltage Vth. The count value of the counter 19 when a person has touched the touch sensor 2 is regarded to equal a value of N4 counted at a time when the waveform W4 goes across the threshold voltage Vth. If the count value is smaller than its threshold value Nth, the CPU 10 determines that a person has not touched the touch sensor 2. If the count value is greater than its threshold value Nth, the CPU 10 determines that a person has touched the touch sensor 2.

Other components shown in FIG. 6 are the same as those described with respect to FIG. 1 and their detailed description is thus omitted.

In the case of FIG. 6 as well, the current required for integrating charge onto the initialized touch sensor 2 is supplied by the constant current circuit 18 in the microcomputer. Therefore, it is not needed to externally attach a large-resistance resistor in series with the touch sensor 2 to the microcomputer 1B. Furthermore, since current that is supplied to the external terminal P1 is a constant current and a level of charging the touch sensor 2 is proportional to time, a high precision of detecting a touch is achieved.

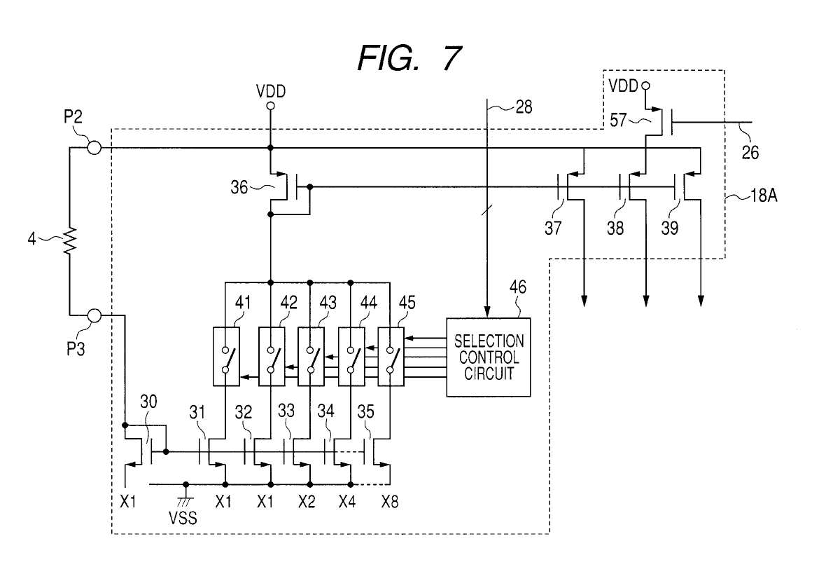

FIG. 7 illustrates the charging-type constant current circuit 18A. In contrast to FIG. 2, MOS transistors 37-39 which mirror the current flowing through the MOS transistor 36 are provided to form a final-stage current mirror circuit and a p-channel MOS transistor 57 as a power switch MOS transistor of the final-stage current mirror circuit is coupled to a common source node for the MOS transistors 37-39. When the MOS transistor 57 is placed in an ON state by a signal 26, the current supply operation to the external terminal P1 is performed. Because other components are the same as those in FIG. 2, their detailed description is omitted.

Although not illustrated specifically, a reference voltage generated by a bandgap reference circuit 90 can also be applied as the power supply for operation of the constant current circuit 18A of FIG. 7, as described with regard to FIG. 3.

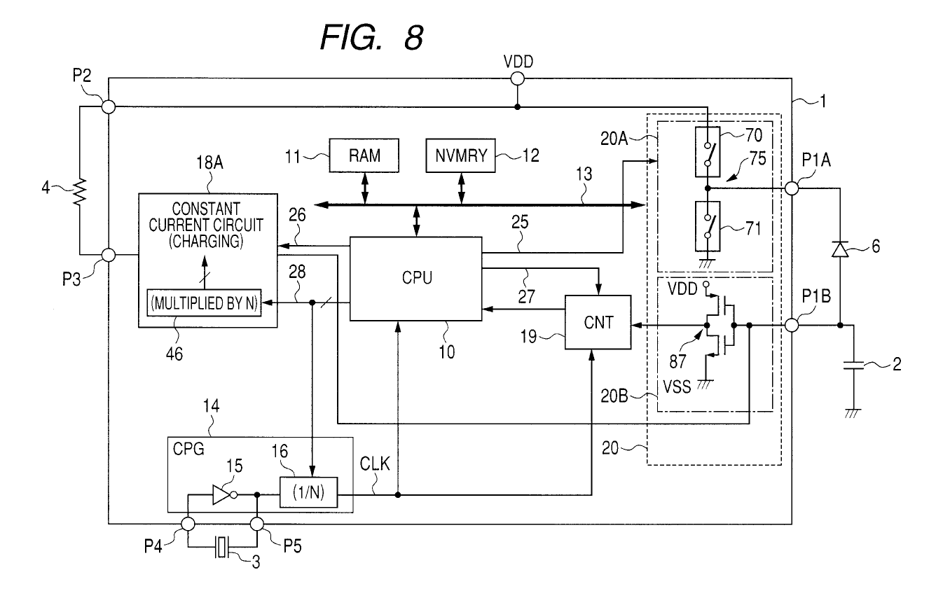

FIG. 8 shows an example in which the output buffer 75 and the input buffer 87 are coupled to separated external terminals used for detecting a touch on the touch sensor in a microcomputer using the charging-type constant current circuit. In the microcomputer 1A of FIG. 8, P1A is an external terminal assigned to the output buffer 75 and P1B is an external terminal assigned to the input buffer 87. A diode 6 that allows current to flow in a forward direction from the external terminal P1B to the terminal P1A is located between the external terminals P1A and P1B. A capacitive electrode of the touch sensor 2 is coupled to the external terminal P1B. In the interface section 20A, one port unit 20A uses only the output buffer 75 for output operation to initialize the touch sensor 2. A current supply node for the constant current circuit 18 is coupled to the external terminal P1B. The input buffer 87 coupling to the external terminal P1B is included in a unit circuit 20B different from the port unit 20A. The unit circuit 20B has no output buffer, at the input node of the input buffer 87, there does not exist a large input capacitance like a source-drain parasitic capacitance of the output buffer employing larger MOS transistors than in the input buffer. The output buffer 75 and the input buffer 87 are coupled to the separated external terminals P1A, P1B and the diode 6 allowing current to flow in the forward direction from the external terminal P1B the external terminal P1A is located between the separated external terminals P1A, P1B. Because a large input parasitic capacitance of the output buffer 75 is not observed from the external terminal P1B, the input parasitic capacitance of the output buffer 75 has no influence on the current integration operation during input operation by the input buffer 87. It is possible to detect a touch with high precision, as is the case in FIG. 5. In the case of FIG. 8, during the input operation by the input buffer 87, the output buffer 75 must be placed in the high output impedance or low level output state.

While the invention made by the present inventors has been described specifically based on its embodiments hereinbefore, it will be appreciated that the present invention is not limited to the described embodiments and various modifications may be made without departing from the scope of the invention.

For instance, in the constant current circuit 18, 18A, the power switch MOS transistor may be dispensed with, because the charging and discharging operations of the output buffer 75 take precedence over the discharging and charging operations of the constant current circuit 18. In a case where the detecting function of microcomputer 1 is not used for detecting a touch on the touch sensor 2, the resistor 4 can not be provided.

Internal configuration of the microcomputer such as types of circuit modules employed and bus coupling can be changed as appropriate, not limited to that shown in FIG. 2. The input circuit is not limited to the input buffer configured by a CMOS inverter and can be changed, as appropriate, to a circuit configured by a logic gate, a comparator, etc. having a predetermined logical threshold. A plurality of touch sensors may be arranged in a matrix, including a plurality of detection nodes in X and Y directions, respectively. It may be possible to configure a touch sensor system in which each detection node is coupled to different external terminals.

What is claimed is:

1. A touch sensor system comprising:
a microcomputer; and
a touch sensor whose capacitive electrode is coupled to an external terminal of the microcomputer,
wherein the microcomputer comprises: a current source circuit coupled to the external terminal; an interface section coupled to the external terminal; a counter circuit coupled to the interface section; and a central processing unit (CPU) controlling the interface section and the counter circuit,
wherein the CPU, after initializing accumulated charge on the touch sensor by an output circuit of the interface section, integrates charge onto the touch sensor with an output current of the current source circuit, acquires a time interval counted by the counter circuit until a signal obtained from an input circuit of the interface section inverts, and discerns whether or not the touch sensor has been touched.

2. The touch sensor system according to claim 1,
wherein the output circuit initializes accumulated charge on the touch sensor by charging operation and the current source circuit is a discharging-type constant current circuit to draw current from an external terminal, and
wherein the CPU, after charging the touch sensor by the output circuit, causes the constant current circuit to draw current, acquires a time interval counted by the counter circuit until a signal obtained from the input circuit inverts due to this current draw, and discerns whether or not the touch sensor has been touched depending on whether or not the time count value has exceeded a threshold value.

3. The touch sensor system according to claim 2,
wherein the external terminal is a common terminal shared by the output circuit and the input circuit, and
wherein the CPU, after charging the touch sensor by the output circuit, places the output circuit in a high output impedance state.

4. The touch sensor system according to claim 2,
wherein the output circuit and the input circuit are coupled to separate external terminals respectively, and
wherein a diode allowing current to flow in a forward direction from a first external terminal for the output circuit to a second external terminal for the input circuit is located between the first and second separate external terminals.

5. The touch sensor system according to claim 1,
wherein the output circuit initializes accumulated charge on the touch sensor by discharging operation,
wherein the current source circuit is a charging-type constant current circuit to supply current to an external terminal, and
wherein the CPU, after discharging the touch sensor by the output circuit, causes the constant current circuit to supply current, acquires a time interval counted by the counter circuit until a signal obtained from the input circuit inverts due to this current supply, and discerns whether or not the touch sensor has been touched depending on whether or not the time count value has exceeded a threshold value.

6. The touch sensor system according to claim 5,
wherein the external terminal is a common terminal shared by the output circuit and the input circuit, and
wherein the CPU, after discharging the touch sensor by the output circuit, places the output circuit in a high output impedance state.

7. The touch sensor system according to claim 5,
wherein the output circuit and the input circuit are coupled to separate external terminals respectively, and
a diode allowing current to flow in a forward direction from a second external terminal for the input circuit to a first external terminal for the output circuit is located between the first and second separate external terminals.

8. The touch sensor system according to claim 1,
wherein the current source circuit is a constant current circuit,
wherein the constant current circuit comprises a current mirror circuit, and
wherein the current mirror circuit outputs a current whose value is set depending on a resistance value of a resistor that is externally attached to the microcomputer via dedicated terminals.

9. The touch sensor system according to claim 1,
wherein the current source circuit is a constant current circuit,
wherein the constant current circuit comprises a current mirror circuit in which a current mirror ratio of output current is selected by a selection circuit, and
wherein the current mirror circuit outputs a current whose value is set depending on the current mirror ratio selected.

10. The touch sensor system according to claim 9,
wherein the CPU causes the selection circuit to select the current mirror ratio in accordance with a relation that a current value determined by the current mirror ratio is inversely proportional to the frequency of a clock signal used for counting operation of the counter circuit.

11. The touch sensor system according to claim 10, further comprising a clock pulse generator generating an operation reference clock signal with a variable frequency for the CPU,
wherein the clock signal used for counting operation of the counter circuit has a predefined frequency division ratio to the operation reference clock signal.

12. The touch sensor system according to claim 11,
wherein the CPU controls the frequency of the operation reference clock signal.

13. The touch sensor system according to claim 11,
wherein the CPU reads, in response to a power-on reset, selection control data that determines the current mirror ratio from a nonvolatile memory and initially sets the selection control data in the selection circuit.

14. A touch sensor system comprising:
a microcomputer; and
a touch sensor whose capacitive electrode is coupled to an external terminal of the microcomputer,
wherein the microcomputer comprises: a constant current circuit coupled to the external terminal; an interface section coupled to the external terminal; a counter circuit coupled to the interface section; a central processing unit (CPU); and a clock pulse generator generating an operation reference clock signal with a variable frequency for the CPU,
wherein a clock signal used for counting operation of the counter circuit has a predefined frequency division ratio to the operation reference clock signal,
wherein the constant current circuit comprises a current mirror circuit in which a current mirror ratio of output current is selected by a selection circuit,
wherein the selection circuit selects the current mirror ratio in accordance with a relation that a current value determined by the current mirror ratio is inversely proportional to the frequency of the clock signal used for counting operation of the counter circuit, and
wherein the CPU, after initializing accumulated charge on the touch sensor by an output circuit of the interface section, integrates charge onto the touch sensor with an output current of the constant current circuit, acquires a time interval counted by the counter circuit until a signal obtained from an input circuit of the interface section inverts, and discerns whether or not the touch sensor has been touched.

15. A microcomputer with an external terminal to which a capacitive electrode of a touch sensor is coupled, the microcomputer comprising:
a current source circuit coupled to the external terminal;
an interface section coupled to the external terminal;
a counter circuit coupled to the interface section; and
a central processing unit (CPU) controlling the interface section and the counter circuit,
wherein the CPU, after initializing accumulated charge on the touch sensor by an output circuit of the interface section, integrates charge onto the touch sensor with an output current of the current source circuit, acquires a time interval counted by the counter circuit until a signal obtained from an input circuit of the interface section inverts, and discerns whether or not the touch sensor has been touched.

16. The microcomputer according to claim 15,
wherein the output circuit initializes accumulated charge on the touch sensor by charging operation,
wherein the current source circuit is a discharging-type constant current circuit to draw current from an external terminal, and
wherein the CPU, after charging the touch sensor by the output circuit, causes the constant current circuit to draw current, acquires a time interval counted by the counter circuit until a signal obtained from the input circuit inverts due to this current draw, and discerns whether or not the touch sensor has been touched depending on whether or not the time count value has exceeded a threshold value.

17. The microcomputer according to claim 15,
wherein the output circuit initializes accumulated charge on the touch sensor by discharging operation,
wherein the current source circuit is a charging-type constant current circuit to supply current to an external terminal, and
wherein the CPU, after discharging the touch sensor by the output circuit, causes the constant current circuit to supply current, acquires a time interval counted by the counter circuit until a signal obtained from the input circuit inverts due to this current supply, and discerns whether or not the touch sensor has been touched depending on whether or not the time count value has exceeded a threshold value.

18. A microcomputer with an external terminal to which a capacitive electrode of a touch sensor can be coupled, the microcomputer comprising:
a constant current circuit coupled to the external terminal;
an interface section coupled to the external terminal;
a counter circuit coupled to the interface section;
a central processing unit (CPU); and
a clock pulse generator generating an operation reference clock signal with a variable frequency for the CPU,
wherein a clock signal used for counting operation of the counter circuit has a predefined frequency division ratio to the operation reference clock signal,
wherein the constant current circuit comprises a current mirror circuit in which a current mirror ratio of output current is selected by a selection circuit,
wherein the selection circuit selects the current mirror ratio in accordance with a relation that a current value determined by the current mirror ratio is inversely proportional to the frequency of the clock signal used for counting operation of the counter circuit, and
wherein the CPU, after initializing accumulated charge on the touch sensor by an output circuit of the interface section, integrates charge onto the touch sensor with an output current of the constant current circuit, acquires a time interval counted by the counter circuit until a signal obtained from an input circuit of the interface section inverts, and discerns whether or not the touch sensor has been touched.
